(19) United States
(12) Patent Application Publication
(10) Pub. No.: US 2002/0113815 A1
(43) Pub. Date: Aug. 22, 2002

(54) Internet ad door

(76) Inventor: Lee Michael DeGross, Fort Lee, NJ (US)

Correspondence Address: Lee M. DeGross, 400 Park Place, #1H, Fort Lee, NJ, 07024, US

(21) Appl. No.: 10/022,627

(22) Filed: Dec. 17, 2001

Related U.S. Application Data
(60) Provisional application No. 60/256,167, filed on Dec. 16, 2000.

(51) Int. Cl. G09G 5/00

(52) U.S. Cl. 345/733; 705/14; 345/764

(57) ABSTRACT

Any number of digital images of a blocking or covering nature, such as a door, that is placed over internet advertisement spaces such as banner ads and ad buttons, of various shapes and sizes (36). When such an ad door image is selected, it disappears in the manner of a door opening, or another uncovering manner, to reveal the advertising contents beneath (66). The advertisement may explode into a larger space to convey its message (37) and collapse back into the original ad space when finished (66). The full attention of the viewer is captured because the viewer chooses to see what is behind the ad door. The ad door also reduces the visual clutter of too many internet advertisements. At the conclusion of an ad door, the space can either be covered with the original ad door image again (36), or covered by the advertiser's name, logo, trademark, slogan, or other such identifying information (66).

### CROSS-REFERENCE TO RELATED APPLICATIONS

This application is entitled to the benefit of Provisional Patent Application Ser.# 60/256,167 filed Dec. 16, 2000.

### BACKGROUND—FIELD OF INVENTION

This invention is a digital internet creation in the field of website multimedia design and development.

### BACKGROUND—DESCRIPTION OF PRIOR ART

A primary goal of an advertisement, regardless of the type of media, is to be seen and heard as often as possible. Advertisements are not effective covered or hidden in any way. To cover, hide, or otherwise block an advertisement is counterintuitive. Maximum exposure of an advertisement is paramount and desirable. Efforts to mitigate an advertisement's exposure are almost non-existent. Therefore, very little prior art is available regarding this mitigation of advertising. Another reason why advertisements are not blocked or masked is because it is physically difficult to place a cover on it and for a consumer to remove it. One certainly cannot cover a highway billboard and expect a consumer to unveil it. The same goes for an advertisement on a side of a city bus or a race car. The difficulty also applies to mass media like radio, television, and the publishing industry. Yet, a brief discussion is warranted to describe the closest relatives of this application's invention.

The internet is an arena where generating sufficient advertising revenue is a major concern. To place an advertisement on the internet is simple. However, to direct the viewer's attention to the internet advertisement is much more difficult. To compel the viewer to select the internet advertisement (a click-through) so that more advertising content is presented is even more difficult.

Advertisements on the internet are exposed like a print ad. Most internet advertisements come in the form of buttons or banners of various sizes with their messages exhibited by default. Most of these buttons and banners explode into a larger image or go forward to an entire website when selected. The end result of all these internet ads is a lot of visual clutter and confusion.

Advertisements called interstitials exist that behave like a television commercial by being the main focus of a page on the internet. Another type of interstitial ad acts like a flyer on a browser window by inserting themselves between, on, or behind other internet browser windows. They disappear when a “close” button is selected. Interstitial ads are annoying because they are unasked for and often block the contents of the internet. They also add to the visual clutter already in evidence.

Standard television and radio do not have the interactivity to block or mask their advertisements. Recently, special boxes and hardware are making it easier for television viewers to skip advertisements. These ad skipping television machines count as minor prior art.

Other minor prior art references are in the field of magazine publishing. There are print ads that present a foldout or centerfold-like spread. The purpose of these is not to hide, but to show a larger picture of an image so that it gives a larger than life feeling. There are occasional ads that ask the reader to rip out a paper cover to show something underneath. In many of these cases, the consumer knows the brand name and intent of these ads before ripping the paper cover off.

All of these examples are the closest manifestations of prior art for this application's invention. An analysis and comparison of these will render the uniqueness of the invention very clearly.

### SUMMARY

In accordance with the present invention a digital blocking image to conceal internet advertisement spaces called banner ads and buttons, of various sizes. The viewer has the choice of selecting the internet ad door to view the advertising contents underneath or to ignore the ad door altogether.

### OBJECTS AND ADVANTAGES

Accordingly, several objects and advantages of my invention are:

(a) to show internet advertisements only if the viewer wants to or wishes to;

(b) to reduce visual clutter on an internet website;

(c) to entice viewers to select an internet ad door by utilizing the “curiosity killed the cat” feeling;

(d) to pacify and appease viewers who don't like advertisements;

(e) to give an internet advertisement button or banner, when they are selected, the opportunity to explode into a bigger space or frame to convey its message and to collapse back into the original smaller space when finished;

(f) to make the advertisement more effective because the viewer is choosing to direct his or her full attention to the advertisement by selecting it;

(g) to give an advertiser the opportunity to create surprising, innovative, and unusual messages that reward the viewer for selecting the internet ad door;

(h) to attach control buttons like pause, replay, stop, fast forward, enlarge, and print to each ad door advertisement that further guarantees the viewer's undivided attention;

(i) to potentially allow a website content provider to charge an advertiser a higher dollar value than a conventional ad button or banner (without the ad door) for each ad exposure because the quality of the viewer's attention is better; and

(j) to make it more accurate to see how much traffic each internet ad door generates because selections or “click-throughs” are simpler to count than banner ads and buttons visible without an ad door.

Further objects and advantages of my invention will become apparent from a consideration of the drawings and ensuing description.

### DRAWING FIGURES

FIG. 1 shows a website page with the internet ad doors in place.

FIG. 2 shows a website page with one exploded advertisement.

FIG. 3 shows the website page without the internet ad doors after the advertisements have run their courses.

FIG. 4 shows a flowchart giving the steps to creating internet ad doors.

Reference Numerals In Drawings

| | |
|---|---|
| 20 website page content | 21 enlarged view of mouse pointer |
| 22 operating system button bar | 24 web browser information, button, |
| | and icon bar |

26, 28, 30, 32, 34, 36-two copies of various internet ad sizes covered by
graphics made to look like doors, drawers, shields, hatches, and handles

| | |
|---|---|
| 37 one exploded advertisement | 38 empty space reserved for internet |
| | ads |
| 39 Uniform Resource Locator box | 40 web browser buttons |
| 42 web browser menu bar | 44 web browser features |

46, 48, 50, 52, 54, 56, 58, 60, 62, 64, 66, 68-blank internet ad space
meant to represent graphics relating to assorted products and services

| | |
|---|---|
| 70 first step in flowchart | 72 second step in flowchart |
| 74 third step in flowchart | 76 fourth step in flowchart |

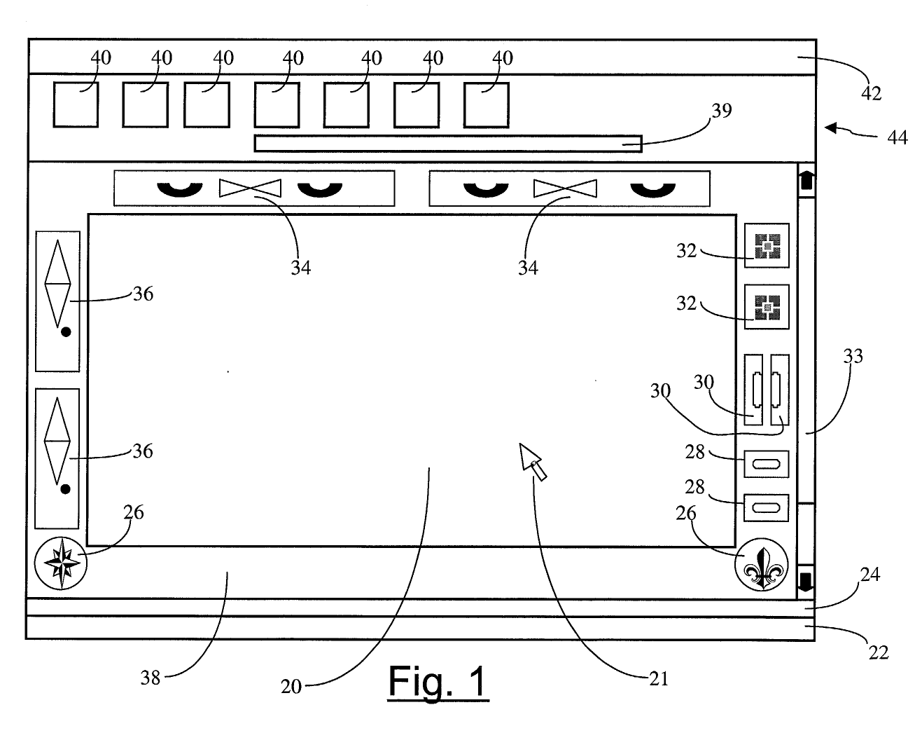

### DESCRIPTION—FIGS. 1, 2, 3, 4

The internet ad door invention is an internet creation and its purpose is to cover the space containing an internet advertisement with a digital image of a blocking device such as a door. The door can be substituted by similar devices such as curtains, shields, lids, hatches, drawers, and handles that imply there is something beneath or behind the device. These covering devices are only a starting point. The internet ad door's identity is endless and can be anything the creative human imagination can make it. From now on, the word “ad door” is taken to mean any of these possibilities.

The ad door operates when the door disappears, uncovers, unfurls, or otherwise opens when selected to reveal the internet advertisement beneath. The selection method is typically a “click on” by a mouse click that directs the pointer on the screen to select the space it is superimposed on. There are various other selection methods such as using the keys on a keyboard, a touch-screen method, a stylus method, and even a voice recognition method. For simplicity's sake, the word “selection” is taken to mean these “click ons” and all the other selection methods.

The spaces exhibiting the advertisements on the internet are called banner ads, ad buttons, icons, and browser windows. These are usually rectangular in shape and the sizes range from a small advertising icon to a medium-sized banner to a browser window that occupies the entire computer monitor.

The internet ad door invention is primarily a process invention. The action is simple and has already been stated but will be reiterated in the section titled “Operation—Preferred Embodiment” for the sake of thoroughness.

The remainder of this section will detail in brief an internet ad door's static physical description which consist of three main areas. They are the computer hardware, the internet as it looks on a computer monitor, and the ad doors themselves as illustrated in the two drawings provided in this RPA.

The internet is accessed by a complex machine called a computer. Nowadays, computers are ubiquitous and drawings of its physical hardware will not be included. Computers have undergone constant changes in form, speed, and memory size and this will continue as computers evolve presently and in the future.

Computers come in all shapes and sizes but share four essential characteristics consisting of the input, processing, memory, and output functions.

Computers range in size from small hand-size personal digital assistants (PDA's) to a briefcase-like laptop PC (personal computer) to a typical desktop PC. Larger computers like workstations and mainframes do not count for this invention because their size is inappropriate for the intended audience of casual internet users.

The descriptions will start with the largest internet-related computers (the desktop computer) and work downwards in size to finish with the PDA's.

The desktop computer (or desktop microcomputer) looks like a television screen sitting atop a square-looking slab about the size of a small suitcase. The television screen is actually a computer monitor and is the primary output device. The computer monitor shows text, images, and animation on the screen. The suitcase slab is actually a box that houses the processing and memory parts. The box, also known as the Central Processing Unit (CPU), is often placed somewhere else such as on the floor or under a desk.

Positioned in front of the monitor and CPU is a flat slab with many buttons called a keyboard. The keyboard is an input device that enters letters, numbers, and other symbols. The mouse is another input device that allows the user to move the cursor to select, point, and draw on the computer screen. The mouse is a very common device and is usually the size of a person's palm. The mouse is placed on a flat surface (like a desk) so when it is moved, the cursor on the computer screen also moves correspondingly. It usually has a few buttons that allow the cursor on the computer screen to “click” or select a particular spot on the screen.

The last major desktop device, the printer, is an output device that comes in all shapes, sizes, and types. The average prineter is typically a laser printer shaped like a medium-sized moving box. The printer's function, as the name implies, is to print or produce the hard copy (paper) output of the computer's work. The printer, though not essential to the invention, is included for the sake of thoroughness.

The laptop PC, by now a very common machine, combines all of the features or devices found on a desktop PC system described above (with the current exception of a printer) into one single unit that is typically the size of a medium-sized telephone book. The laptop is designed to be a portable PC and has a very thin monitor or screen that, when closed, is usually positioned face down facing the keyboard. A hinge or other similar device typically combines the keyboard and monitor and looks like an open clamshell when opened.

The mouse used with a desktop PC is often replaced on a laptop PC by contraptions that serve the same purpose. Laptops are powered like a desktop PC using an electrical outlet, sometimes in combination with batteries (usually rechargeable). Virtually all laptops being built now are able to access the internet, often by wireless means, making it relevant to this invention.

Personal digital assistants (PDA's), have the portability of laptops but are designed to be small enough to fit in a user's hand or a shirt pocket. Many PDA's are pen-based, meaning that a pen-like stylus is used to do the functions of a keyboard and a mouse by touching the PDA's monitor. PDA's are primarily organizers that allow a user to do scheduling functions, act like a notepad, store phone numbers, calculate, and a host of other uses.

Some PDA's are now capable of accessing the internet, often by wireless means, but the monitor usually shows just a portion of a website's contents. The PDA's monitor may get the rest of the website's contents by using a scrolling function to go across, or up, and down. Ambitious attempts are being made to allow a PDA's monitor to display 100% of a websites contents onto its small screen.

Newer PDA's are being built to combine its features with various other electronic gadgets like cell phones, pagers, and the like. Cell phones are portable wireless telephones. Pagers are small devices that alert the user to return a call, or receive and send a message. Essentially any other device, present or future, that is able to access the internet and exhibit the ad door is relevant to this invention.

The internet will now be described briefly. The idea of the internet is simple, a vast network of computers of many types that are connected and are able to interact with one another. The whole of the internet could probably be written about in a series of large books. For this invention's purpose the following definition of the internet is from the IBM Dictionary of Computing. It defines the internet as,“A wide area network connecting thousands of disparate networks in industry, education, government, and research. The Internet network uses TCP/IP as the standard for transmitting information.”

The TCP/IP is defined by the same dictionary as,“Transmission Control Protocol/Internet Protocol. A set of communication protocols that support peer-to-peer connectivity functions for both local and wide area networks.”

The most relevant feature regarding the internet for this invention is the World Wide Web (WWW). The WWW, with its ability to handle graphics, multimedia, and hypertext links is included here since the ad door will mostly use WWW website addresses and capabilities. The internet spans many countries, consists of thousands of networks, has millions of users, and will continue to grow and improve.

The ad door invention is not limited to WWW websites. The invention can be used in future generation World Wide Webs and future internets employing internet/television hybrids.

The WWW is navigated or surfed with the help of a commercial web browser. A website's address is accessed when its URL (Uniform Resource Locator) or domain name is invoked on the browser's domain name locator. For WWW websites, their address begins with the prefix “www” as in www.websitename.com. The suffix “.com” is a government-created categorization representing the commercial industry. Other examples of these suffixes are “.net”, “.org”, “.edu”, “mil” and “.gov”. More such suffixes will undoubtedly be created.

A basic description of the computer hardware with its ability to access the internet and the internet itself has been given. The remainder of this static description will describe the three drawings and one flowchart that are included in this RPA.

FIG. 1 shows what a website page looks like on a computer monitor with the internet online. There are standard web browser features 44 like navigation tools 40, and icon or button bars 24, a web browser menu bar 42, and a space for internet URL's (or internet domain names) 39. A scrolling bar is shown on the right of the webplay stage 33. Other things that are displayed outside a website page contents 20 are various buttons and icons and drawings related to a computer's operating system 22. A mouse pointer 21 is shown larger than actual size and represents the primary selection method.

FIG. 1 presupposes that the website creators have reserved the edges of a webpage 38 for advertising content. This space contains two copies of various internet ad sizes covered by graphics made to look like doors, drawers, shields, hatches, and handles 26, 28, 30, 32, 34, 36. There is empty space 38 reserved for other internet ad sizes to be displayed at a later time.

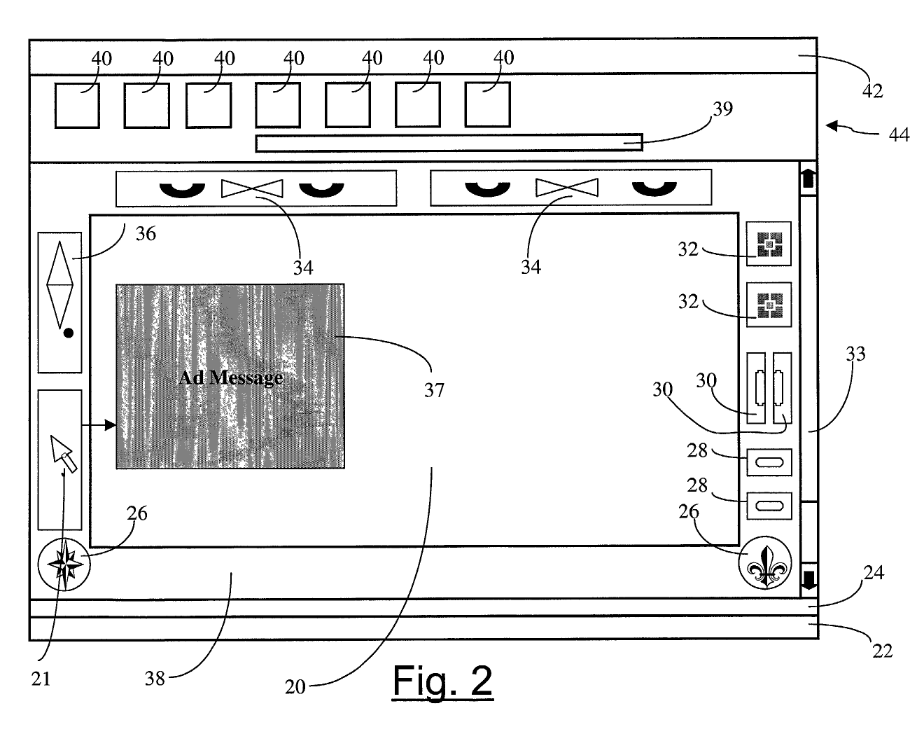

FIG. 2 shows the result of one ad door 36 that was selected and subsequently exploded into a larger space 57, with the advertising message. Just before an exploded advertisement 57 sprouted, an ad door handle 36 had lifted up and the door was swung open.

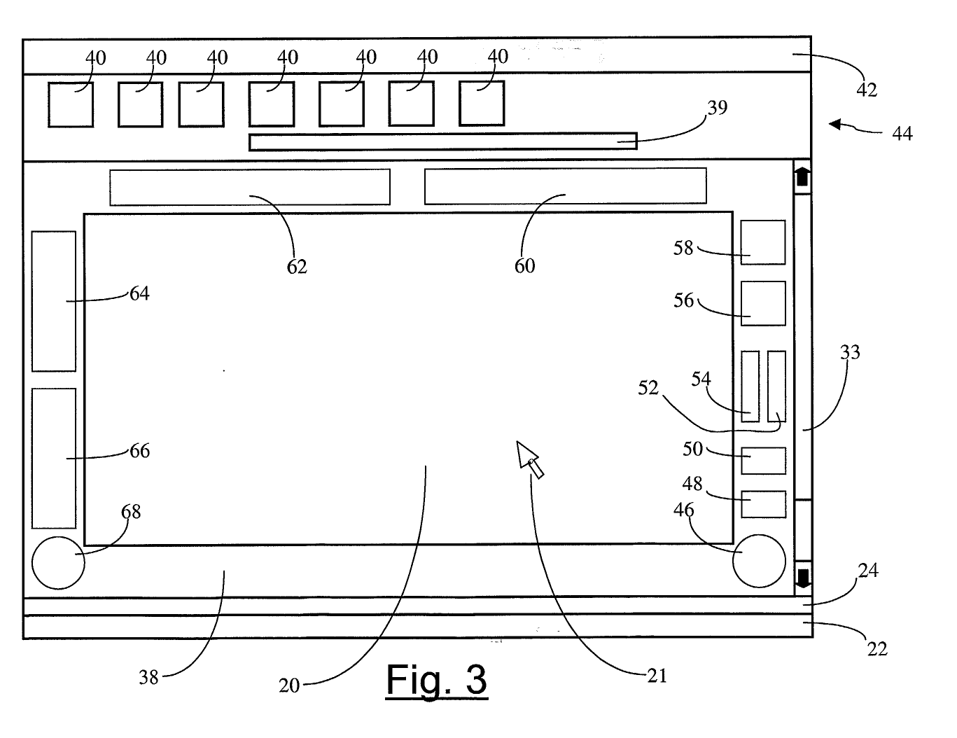

FIG. 3 shows the same area as in FIG. 1 and FIG. 2 except that the ad spaces of various sizes are blank. This means that all the ad doors had been selected and each advertisement had run its course. The blankness is meant to be substituted by the actual images relating to assorted products and services being advertised 46, 48, 50, 52, 54, 56, 58, 60, 62, 64, 66, 68 such as brand names, logos, trademarks, slogans, etc.

In this instance in FIG. 3, each ad door did not redisplay the images of the original doors, drawers, shields, hatches, and handles 26, 28, 30, 32, 34, 36. Instead it was decided that the images of the products and services 46, 48, 50, 52, 54, 56, 58, 60, 62, 64, 66, 68 would show.

Some of these finished ad doors had exploded into larger spaces to better convey their advertising message as shown in FIG. 2 of ad door 36.

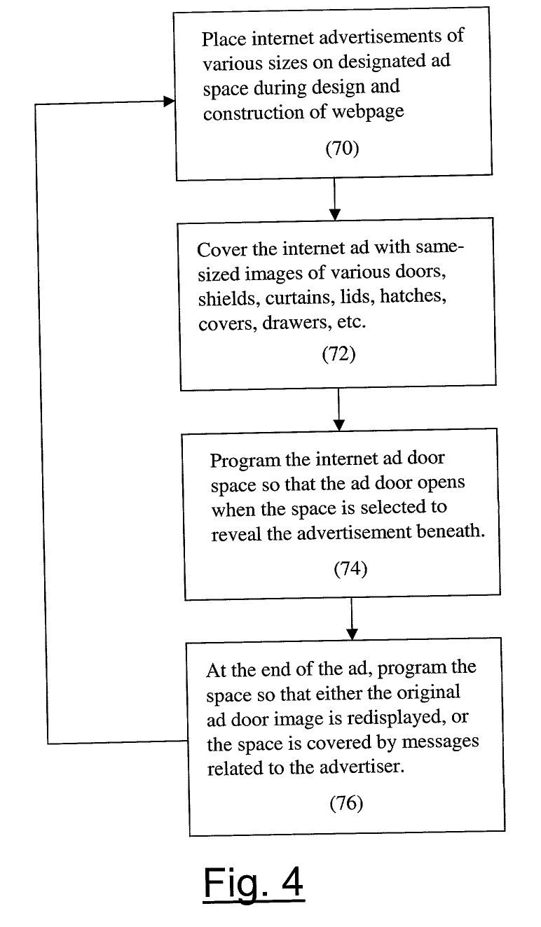

FIG. 4 shows a flowchart detailing the steps to be taken when constructing the internet ad door invention 70, 72, 74, 76. A programmer or person reasonably skilled in the field of website design and development can perform these steps.

Operation—Preferred Embodiment

As stated in the preceding description, the purpose of the internet ad door is to bock, substantially and contiguously, the space containing the internet advertisement. This is done with a non-advertising image or illustration or non-advertising moving images or illustrations of sufficient size to serve as a door. When the non-advertising image is selected, the door opens, disappears, uncovers, or unfurls to reveal the advertisement beneath.

This invention uses images that look like a door or any other device implying something is behind or beneath it as the internet ad door. These other devices of a blocking nature include but are not limited to curtains, hatches, screens, shrouds, cloaks, shields, canopies, facades, masks, tents, umbrellas, envelopes, hats, manhole covers, caps, lids, hoods, guards, rocks, rockets, candy wrappers, bombshells, cannons, balloons, and even clouds.

The preferred embodiment of the internet ad door invention is to use creativity and fun in executing variations of the “open the ad door” theme. For example, suppose the ad door is a manhole cover. When the manhole ad door is selected, an animated construction worker with a hardhat appears and trudges toward the manhole in a funny and entertaining manner. The worker uses a crowbar to latch on and lift the manhole cover. The advertisement will then appear, and explode into a larger space if need be.

This theme of “opening the ad door”, oftentimes with an animated person doing the work, has innumerable variations. A few more will be described. The first, the gift wrapping, is a favorite because of its simplicity, elegance and many possible variations;

(1) An ad door is covered by an image of gift wrapping paper with ribbons and lace. When the gift wrapping ad door is selected, the ribbon and lace slowly untie, the wrapping is torn off, and the box top is opened to reveal the advertisement. This can be done in either two dimensional or three dimensional formats.

(2) An ad door is covered by an image of a black belt martial arts expert in a fighting stance facing the viewer with various combative expressions. When the karate man ad door is selected, he changes his stance to attention, bows respectfully, and steps aside to reveal the advertisement.

(3) An ad door is covered by an image of an envelope with stamps and after it is selected, the famous Robin Hood appears and shoots an arrow that rips open the envelope to reveal the advertisement.

(4) An ad door is covered by an image of interlocking clouds. When it is selected, a face appears in profile and blows into a trumpet to blow away the clouds to reveal the advertisement.

(5) An ad door is covered by an image of a plane in sideways view with the pilot waving with his hands. When it is selected, the plane flies across towing a long banner that bears the advertisement's message.

(6) An ad door is covered by an image of a large tent. When it is selected, the tent collapses and folds to reveal the advertisement.

(7) An ad door is covered by an image of a bottle. When it is selected, a hand opens the bottle-top and the advertisement spills out like bubbly.

(8) An ad door is covered by an image of rocks. A person comes striding by and kicks the rocks to reveal the advertisement.

(9) An ad door is covered by an image of a child's face that is winking. When it is selected, the face blows a large bubble from a bubble gum stick and after it pops the advertisement is revealed.

(10) An ad door is covered by an image of a submarine-like hatch with a wheel handle. When it is selected, a sailor appears and turns the wheel handle just in time to avoid the rising water level. The water recedes to reveal the advertisement.

(11) This last example has an ad door covered by a likeness of a famous movie star who is standing next to a sailboat. When it is selected, the love interest co-star appears and both of them kiss and climb into the boat and sail away. An advertisement is then shown that promotes the romantic movie.

Clearly, the creative possibilities for the ad door are immense. The above is but only a few that can be used.

After an ad door is finished with its message, the brand name or other identifying information of the advertiser may or may not be visible in the banner or button space. Two examples illustrate this. A gift wrapped ad door, in a typical banner space, gets torn open after selection and the advertisement runs its course. At the end of the message, the advertisement collapses and the gift wrapping appears again to cover the ad door space.

The other option is not to cover the ad door space with the original gift wrap at the conclusion, but to display the advertiser's brand name, logo, slogan, trademark, or other identifying information in its place.

The preferred embodiment is to have the original ad door image appear again after the conclusion of the advertisement. There are two reasons for this. The first reason is that visual clutter is reduced. Instead of having annoying corporate logos and the like blaring on the screen, the sedate ad door images are in place. The second reason is that by showing the ad door images again, the user might be enticed to select the ad door again to see a repeat of the advertisement for any number of reasons.

One such reason might be that the user did not recall the advertiser's name (like an insurance company) and wants to find out. Another reason might be that the user thinks the advertising spot especially funny and wants to view it again. Still another reason might be that the user forgot a detail of the advertisement, like a telephone number or the date of a movie premier, and wants to double-check.

In all these repeat selection cases, the advertisement gets another click-through for another “impression” (to use internet terminology) and garners the user's undivided attention.

Description and Operation of Additional Embodiments

A major additional embodiment is to have an ad door be a short motion picture, television, video, or digital clip that plays when selected and disappears to reveal the advertisement. For example, a facial image of the famous actor, Gene Kelly, is used as an ad door. When selected, Kelly's face recedes and the famous clip plays of him singing and dancing in the rain in “Singing in the Rain”. The advertisements is revealed after the clip ends.

Another example has an image of a person on a bicycle as an ad door. When selected, a short television clip plays that shows the person on the bike get into a humorous accident in the manner of a “bloopers” television show. The advertisement runs after the clip ends.

A short funny clip from a cartoon show, such as the Flintstones, can be used as an ad door in the manner described above. Likewise, a short clip from a music video from MTV Productions also can be used in the same way. Obviously, this embodiment has endless variations. Even clips from television commercials can be used, creating ironically, an advertisement in front of an advertisement.

Other, less exciting embodiments have the ad door shown as any combination of words and images that are not as sophisticated as the ones described above. For example, the ad door space may simply be colored blue with the words “open” or “click here” displayed. Another example is a photograph of the Manhattan skyline as the ad door. Still another example is a simple image of venetian window blinds as the ad door that opens in its distinctive way when selected. There are endless variations of these basic themes.

Another embodiment of the ad door allows the viewer to control the advertisement after it is selected. The advertisement can be attached with buttons and control knobs that enable the viewer to pause, play, stop, fast forward, playback (rewind), replay, enlarge, shrink, close, print out, increase or decrease the volume, and other such functions.

Another minor embodiment of the ad door is to create more depth perception in the images (three dimensional style), which are typically two dimensional and flat. To use a bottle as an example, the three dimensional style creates an effect where the viewer can see the curvature of the round bottle and makes it look like it can be grasped. This is different from the typical flat single line drawing of a bottle.

Conclusion, Ramirications, and Scope of Invention

Thus the reader can see how a simple invention like the internet ad door can solve several problems at once. A viewer of a website who does not care for advertising will be spared from them without having to do anything, thanks to the ad door. The ad door reduces visual clutter on a website because the advertisements and their messages are hidden from view. In its place are digital illustrations of various covering contrivances such as a door that are a welcome relief from distracting internet advertisements that do not have such coverings.

Moreover, advertisers who use the ad door benefit in several ways. Advertisers command the viewers' undivided attention because the viewer took the initiative to see and hear the advertisement by selecting it. An ad door works in a crafty way to attract attention because it acts on the “curiosity killed the cat” feeling. A viewer may think, “What is behind that thing?” and act on it by selecting the ad door.

When an ad door is selected, the advertiser can reward the viewer's curiosity by showing surprising, fun, and unusual advertisements in a variety of creative ways.

When a viewer selects an ad door, this action gives the advertiser the option of exploding the ad door's small button or banner space into a larger space or frame to better convey their message. After the advertisement runs its course, it can collapse back to the smaller button or banner space.

The quality of the attention possibly permits a website to charge more for each view or “impression” of an ad door than for a typical advertisement without a cover.

Each ad door can include control button features such as pause, play, stop, fast forward, playback (rewind), and replay, which further guarantees the viewer's undivided attention to the advertisement.

While my above description contains many specificities, these should not be construed as limitations on the scope of the invention, but rather as an exemplification of one preferred embodiment thereof. For example, instead of using the “opening the door” theme to front an advertisement, very short movie and television clips can be used in its place.

Accordingly, the scope of the invention should be determined not by the embodiments illustrated, but by the appended claims and their legal equivalents.

I claim:

1. A first means for blocking and revealing internet advertising comprising:
(a) a second means for placing an image or images of a blocking nature of sufficient size to substantially conceal an internet advertising space,
(b) a third means for using a selection method to choose and make the blocking image or images disappear and reveal said internet advertising,
whereby a human can view and hear said internet advertising only if said human wants by using said selection method.

2. The internet of claim 1, further including various existing internet networks, future generation internet networks, and internet networks with internet/television hybrids.

3. The selection method of claim 1, further including methods like a mouse click method, a keyboard key or keys method, a touch-screen method, a stylus method, and a voice recognition method.

4. A device for superimposing a non-advertising illustration or non-advertising moving illustrations contiguously over an internet advertisement includes:
(a) providing a means for said non-advertising illustration or non-advertising moving illustrations of claim 2 to go into action and remove itself in an entertaining manner when selected by a person,
(b) so that said internet advertisement is exposed and able to convey its contents to said person,
whereby said person, without taking any action, is shielded from said internet advertisement by said non-advertising illustration or non-advertising moving illustrations, and
whereby said internet advertisement is shown only if said person wishes to by selecting said non-advertising illustration or non-advertising moving illustrations.

5. The internet of claim 4, further including various existing internet networks, future generation internet networks, and internet networks with internet/television hybrids.

6. The selection method of claim 4, further including methods like a mouse click method, a keyboard key or keys method, a touch-screen method, a stylus method, and a voice recognition method.
